(19) United States
(12) Patent Application Publication
(10) Pub. No.: US 2018/0223506 A1
(43) Pub. Date: Aug. 9, 2018

(54) SYSTEM AND METHOD FOR AUTOMATED PREVENTION OF FREEZING OF A LIQUID IN A PLUMBING NETWORK

(71) Applicant: Ziad Abou HARB, Edmonton (CA)

(72) Inventor: Ziad Abou HARB, Edmonton (CA)

(21) Appl. No.: 15/750,405

(22) PCT Filed: Aug. 5, 2016
(86) PCT No.: PCT/CA2016/050922

§ 371 Date: Feb. 5, 2018

Related U.S. Application Data
(60) Provisional application No. 62/201,976, filed on Aug. 6, 2015.

(51) Int. Cl. E03B 7/12; E03B 7/10; F16K 31/00

(52) U.S. Cl. CPC E03B 7/12; F16K 31/002; E03B 7/10

(57) ABSTRACT

A system that automatically prevents freezing of a liquid in a plumbing network includes an electrical temperature sensor, an electromechanical shut-off valve, a pump (such as an air compressor pump and a vacuum pump) and an operatively connected computer. The computer determines if the temperature detected by the electrical temperature sensor is within a predetermined range of a threshold temperature. If so, the computer actuates the shut-off valve to prevent the liquid from flowing from a liquid source to a portion of the plumbing network, and actuates the pump to discharge the liquid from the portion of the plumbing network to the liquid drain. The computer may actuate additional electromechanical valves on the plumbing network to facilitate discharge of the liquid, and on a supply line to allow the liquid to continue circulating in the supply line.

### TECHNICAL FIELD OF THE INVENTION

The present disclosure relates generally to systems and methods for prevention of freezing of liquids in plumbing networks.

### BACKGROUND TO THE INVENTION

When water freezes in a plumbing network, the water may expand and damage the plumbing lines, and leak from the plumbing lines. The resulting property damage to a building and its contents can be extensive if the leak remains undetected for a significant time. A common scenario that gives rise to this risk is the failure or deactivation of the heating system of a building that is vacant during the winter months.

The prior art includes methods and systems for preventing water from freezing in plumbing networks of building structures. A faucet tap may be left slightly open to let a small amount of water trickle out of the faucet so that the continuous flow of water through the plumbing network helps to prevent the water from freezing. In accordance with this principle, some systems circulate water through the plumbing network during cold temperatures. However, water is still present inside the plumbing networks and therefore the risk of freezing remains present. Further, such systems can waste water and energy, if engaged for extended periods.

Other systems attempt to drain the water out of the plumbing network when the temperature in a building drops near or below freezing. U.S. Pat. No. 5,220,937 (Roberts et al.) and U.S. Pat. No. 4,730,637 (White) disclose examples of such systems. In addition, some systems that automatically drain water from lines include sensors that measure the interior temperature in a building at only one location. However, there can be significant temperature variations between different positions in a building structure. If the temperature sensor is located at a position of a building that is warmer than another, then the water may freeze in parts of the plumbing network in the cooler location before the system is activated to drain the plumbing network.

There remains a need for systems and methods for preventing freezing of water in plumbing networks. Preferably, such systems and methods are fully automated, capable of draining all plumbing lines in the building and responsive to ambient temperature in numerous locations in a building.

### SUMMARY OF THE INVENTION

The present invention allows for the automatic discharge of liquid from a plumbing network in response to the detection of near-freezing or sub-freezing temperatures. Thus, the invention may reduce the risk of damaged lines in plumbing networks due to freezing of the liquid and the resulting property damage. In this document, the term “plumbing network” refers to one or more lines that convey liquid supplied from a liquid source. In this document, the term “line” in the context of the plumbing network includes, without limitation, members commonly referred to as pipes, tubes or lines, whether made of metal, plastic or other materials, and whether rigid or flexible. In this document, the term “liquid” refers to any substance in a liquid state including, but not limited to, water. It will therefore be understood that the present invention may be used with plumbing networks used to convey water in buildings, as well as a variety of other networks for conveying liquids in other applications such as liquid production and processing systems used in industrial applications.

In aspects, the present invention comprises a system and a computer-implemented method for automated prevention of freezing of a liquid in a plumbing network connected to a liquid source and a liquid drain. The system of the present invention comprises at least one electrical temperature sensor, an electromechanical shut-off valve actuable to prevent the liquid from flowing from the liquid source to at least a portion of the plumbing network, a pump for discharging the liquid from the portion of plumbing network to the liquid drain, and a computer. The computer comprises a processor operatively connected to the temperature sensor, the shut-off valve, the pump, and a non-transitory medium that stores instructions readable by the processor. The computer implements the method, which comprises determining if the temperature detected by the electrical temperature sensor is within a predetermined range of a threshold temperature. In response to determining that the temperature is within the predetermined range of the threshold temperature, the system takes a related action. The related action comprises actuating the shut-off valve to prevent the liquid from flowing from the liquid source to the portion of the plumbing network, and actuating the pump to discharge the liquid from the portion of the plumbing network to the liquid drain.

In embodiments, the plumbing network defines an auxiliary inlet or outlet, and the system further comprises an electromechanical auxiliary valve actuable to close and open the auxiliary inlet or outlet. The processor is operatively connected to the auxiliary valve. The related action further comprises actuating the auxiliary valve to open the auxiliary inlet or outlet.

In embodiments, the pump is an air compressor pump, and actuating the pump to discharge the liquid from the portion of the plumbing network to the liquid drain comprises the pump pressurizing air into the plumbing network.

In embodiments, the pump is a vacuum pump, and actuating the pump to discharge the liquid from the portion of the plumbing network to the liquid drain comprises the pump creating a suction to draw the liquid out of the plumbing network.

In embodiments, the related action further comprises generating an audible or visual notification that the temperature is within the predetermined range of the threshold temperature. In embodiments, the related action may further comprise waiting to receive a response to the notification. Either actuating the shut-off valve or actuating the pump, or both actuating the shut-off valve and actuating the pump may be conditional on not receiving the response within a predetermined amount of time from generating the notification.

In embodiments, a supply line connects the liquid source to the plumbing network and the supply line defines a supply line outlet upstream of the shut-off valve. The system may further comprise an electromechanical supply valve actuable to close and open the supply line outlet. The processor is operatively connected to the supply valve. The related action may further comprise actuating the supply valve to open the supply line outlet.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted is but one of a number of possible arrangements utilizing the fundamental concepts of the present invention. The drawings are briefly described as follows:

FIG. 1 is a schematic representation of an embodiment of a system of the present invention for automated prevention of freezing of a liquid in a plumbing network in a building with multiple floors;

FIG. 2 is a schematic representation of a base module of the embodiment of the system shown in FIG. 1;

FIG. 3 is a schematic representation of the computer and its operative connections to other components of the embodiment of the system shown in FIG. 1;

FIG. 4A is a schematic representation of an auxiliary valve assembly of the embodiment of the system shown in FIG. 1 for an upper floor line of the plumbing network;

FIG. 4B is a schematic representation of an auxiliary valve assembly of the embodiment of the system shown in FIG. 1 for a lower floor line of the plumbing network;

FIG. 5 is a schematic representation of an embodiment of the system shown in FIG. 1, with additional components to protect liquid from freezing in the supply line serving the plumbing network; and

FIG. 6 is a flow diagram illustrating an embodiment of a method of the present invention for automated prevention of freezing of a liquid in a plumbing network, as implemented by the embodiment of the system shown in FIG. 1.

### DETAILED DESCRIPTION OF EMBODIMENTS OF THE INVENTION

The present invention comprises systems and methods for automated prevention of freezing of a liquid in a plumbing network. Non-limiting embodiments of such systems and methods are now described with reference to the drawings.

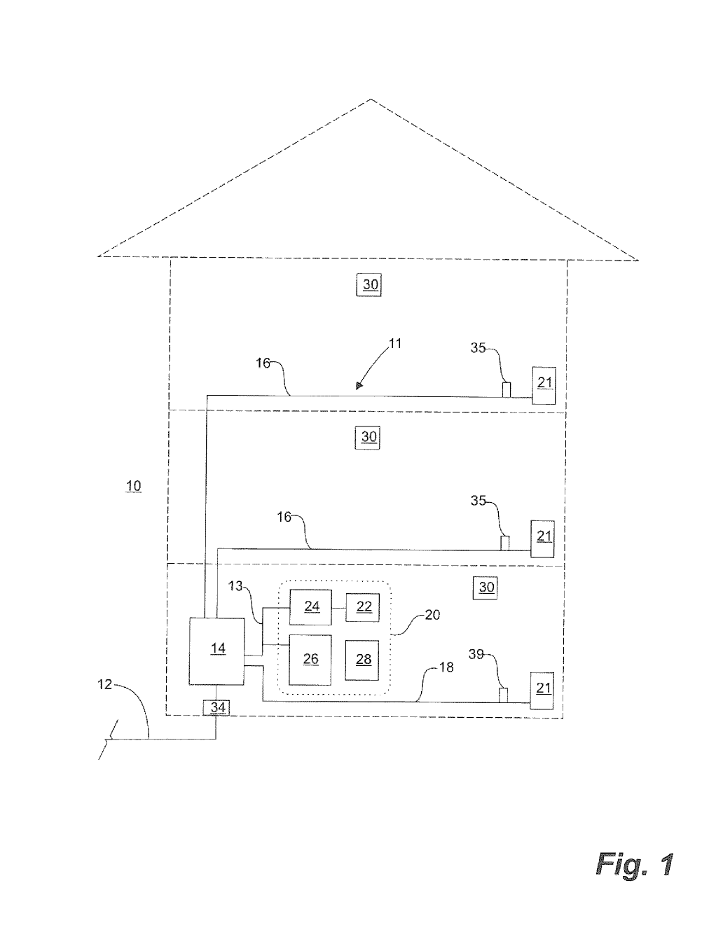

FIG. 1 shows a schematic representation of an embodiment of a system (10) of the present invention used to prevent freezing of water in a plumbing network (11) internal to a house. In the exemplary embodiment shown in FIG. 1, the plumbing network (11) receives water from a liquid source in the form of a municipal drinking water supply line (12) that supplies drinking water under pressure. The plumbing network (11) includes a liquid drain (13), a cold or hot water manifold (14), an upper floor line (16), and a lower floor line (18). The liquid drain (13) provides a discharge point for the plumbing network (11). The manifold (14) directs the water to the upper floor line (16) and the lower floor line (18) for distribution to a variety of fluid destinations (21) such as faucets and toilets. It will be understood that the system (10) is not limited by the exemplary configuration of the plumbing network (11) shown in FIG. 1.

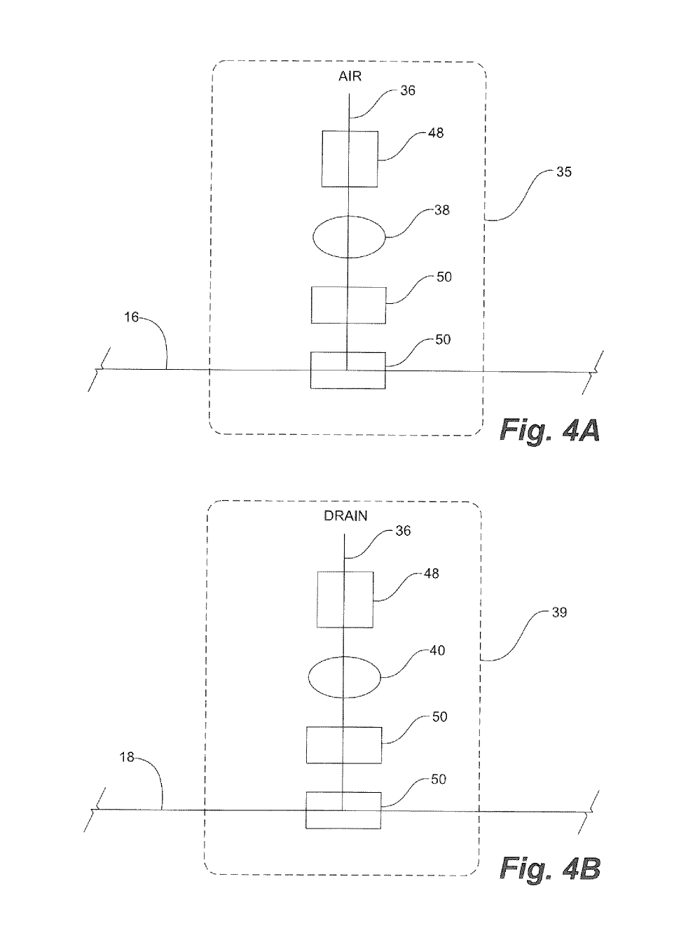

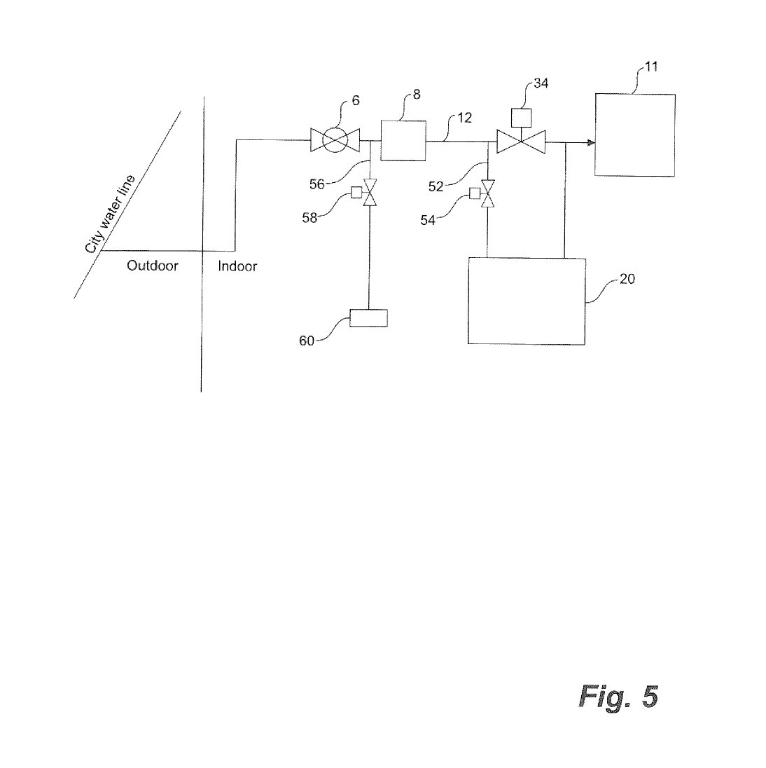

In general, the system (10) comprises at least one electrical temperature sensor (30), at least one electromechanical shut-off valve (34), at least one pump (22, 26), and a computer (28). In the exemplary embodiment, the system (10) also comprises a tank (24). In the exemplary embodiment, the pump (22, 26), the tank (24) and the computer (28), collectively form a base module (20) that is disposed in the lower floor of the building. In other embodiments of the system (10), these components may be distributed in other parts of the building or placed partially outside of the building, provided they are protected from the elements. In the exemplary embodiment shown in FIGS. 4A and 4B, the system (10) also comprises auxiliary valve assemblies (35, 39) for the upper and lower floor lines (16, 18), respectively. In the exemplary embodiment shown in FIG. 5, the system (10) also comprises a supply valve assembly.

The purpose of the electrical temperature sensors (30) is to detect the temperature of the liquid in the plumbing network (11) or near the plumbing network (11), and to output an electronic signal indicative of the temperature. Any suitable temperature sensor known in the art may be used, including without limitation variable resistance temperature detectors, and thermocouples. In the embodiment shown in FIG. 1, the system (10) includes a plurality of temperature sensors (30) positioned to monitor ambient air temperature at many locations of the building. In other embodiments, the system (10) may have a fewer or greater number of temperature sensors (30), and the temperature sensors (30) may be positioned to monitor the temperature at selected locations of the plumbing network (11) or to monitor the temperature of the liquid itself in selected portions of the plumbing network (11).

The purpose of the electromechanical shut-off valve (34) is to isolate at least a portion of the plumbing network (11) from the liquid source by preventing the liquid from flowing from the liquid source to the isolated portion of the plumbing network (11). The shut-off valve may comprise any suitable electromechanically actuated valve known in the art including, without limitation, a solenoid valve, which can be actuated by the computer (28) as described below. In the embodiment shown in FIG. 1, the shut-off valve (34) is positioned on the supply line (12) to be actuable to prevent water from the municipal water supply system (not shown) from flowing to the substantial entirety of the plumbing network (11).

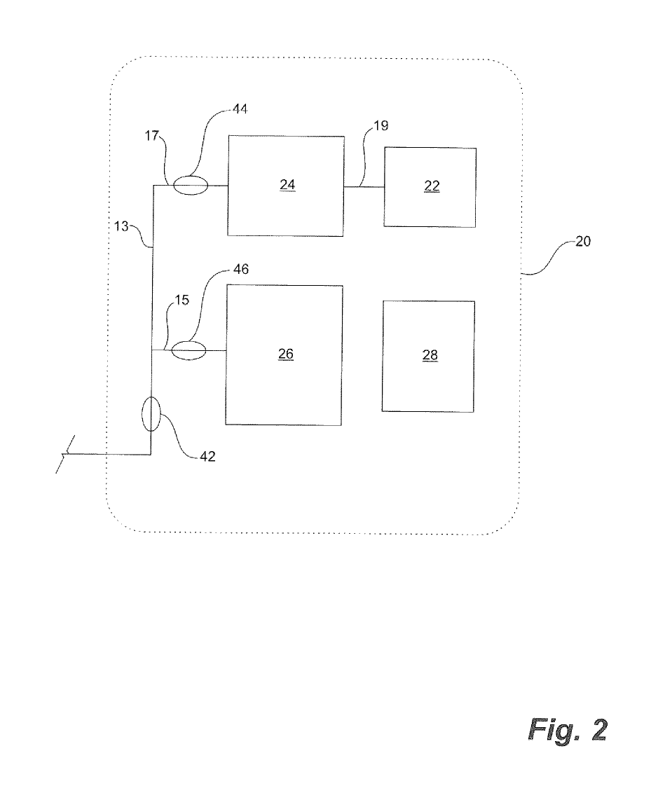

The purpose of the pump (22, 26) is to discharge the liquid from the portion of the plumbing network (11) isolated by the shut-off valve to the liquid drain (13). The pump (22, 26) may comprise any suitable device known in the art for creating a pressure differential between the liquid in the plumbing network (11) and the liquid at the liquid drain (13). The pump can comprise a positive pressure device and/or a negative pressure device. In the exemplary embodiment, as seen in FIG. 2, the pump comprises an air compressor pump (26) fluidly connected to the lower floor lines (18) as well as a vacuum pump (22) that is fluidly connected to the upper floor lines (16). The purpose of the air compressor pump (26) is to create a positive pressure differential by providing a source of air that can be discharged into lower floor lines (18) to displace the liquid out of lower floor lines (18). The purpose of the vacuum pump (22) is to create a negative pressure differential by providing suction that can draw out the liquid contained in upper floor lines (16). It will be understood that the system (10) may comprise both the air compressor pump (26) and the vacuum pump (22) as shown in the Figures, or only one of the air compressor pump (26) and the vacuum pump (22).

The exemplary embodiment of the system (10) shown in FIGS. 1 and 2 further comprises a tank (24). The purpose of the tank (24) is to receive and hold the liquid discharged from the liquid drain (13). In an exemplary embodiment, the tank (24) may be equipped with an auxiliary pump (not shown), which can be used to pump the fluid collected in the tank (24) to another drain. Referring to FIG. 2, the exemplary embodiment of the system (10) further comprises several valves for regulating flow in the plumbing network (11) and the pumps (22, 26). A solenoid valve (42) positioned on the liquid drain (13) isolates the base module (20) from the manifold (14). A solenoid valve (44) positioned on line (17) isolates the liquid drain (13) from the water tank (24) and the vacuum pump (22). A solenoid valve (46) positioned on line (15) isolates the air compressor pump (26) from the liquid drain (13). These solenoid valves may be actuated by the computer (28) as further described below.

In the exemplary embodiment of the system (10) shown in FIGS. 4A and 4B, the system (10) further comprises auxiliary valve assemblies (35, 39) for the upper floor line (16) and the lower floor line (18), respectively. The purpose of the auxiliary valve assemblies (35, 39) is to facilitate the discharge of the liquid from the plumbing network (11). In the exemplary embodiment, each of the auxiliary valve assemblies comprises an auxiliary line (36) fluidly connected to and branching from the upper floor line (16) or lower floor line (18), as the case may be. Auxiliary lines (36) may be positioned on upper (16) or lower (18) floor lines near the fluid destinations (21) of these water lines, for example but without limitation, a sink, a toilet, or appliance. As seen in FIG. 4A, the auxiliary line (36) connected to the upper floor line (16) defines an auxiliary inlet that can be opened to the atmosphere (“AIR”) at the end of the auxiliary line (36). In contrast, as seen in FIG. 4B, the auxiliary line (36) connected to the lower floor line (18) defines an auxiliary outlet that can be fluidly connected to a drain (“DRAIN”), which may in embodiments be another liquid drain (not shown) for the plumbing network (11) (e.g., a basement floor drain or a sink drain). The person skilled in the art will appreciate that, in connecting the auxiliary line (36) of the auxiliary valve assembly (39) to drain, it may be necessary to select a suitable connection to prevent mixing of potable water and wastewater.

The auxiliary valve assemblies (35, 39) further comprise electromechanical auxiliary valves (e.g., solenoid valves) that are positioned on the auxiliary lines (36) and that can be actuated by the computer (28), as further described below. In embodiments, the auxiliary valve assemblies (35, 39) also comprise check valves (48) positioned on the auxiliary lines (36) so that the liquid flow in the auxiliary lines (36) may be limited to one direction only. In embodiments, the auxiliary valve assemblies (35, 39) further comprise ball valves (50) on the auxiliary lines (36) and at the intersection of auxiliary lines (36) with the upper floor line (16) or the lower floor line (18), as the case may be. The ball valves (50) are normally left open to allow the system (10) to discharge the plumbing network (11), as described below. However, ball valves (50) can also be manually closed if there is a malfunction of system (10) to allow the plumbing network (11) to operate normally during the malfunction.

It is known that if water freezes in the bowl or tank of a toilet, damage can occur to the toilet. This again would necessitate expensive and inconvenient repairs. Therefore, in exemplary embodiments, the system (10) may also include electromechanical actuators (hereinafter referred to as “flushers”) (not shown) to flush toilets connected to the plumbing network (11), wherein the flushers can be actuated by the computer (28), as further described below.

Referring to FIG. 5, in an exemplary embodiment, the system (10) further comprises additional electromechanical supply valves (e.g., solenoid valves) (54, 58) to protect the supply line (12) upstream of the shut-off valve (34). In an exemplary embodiment, a solenoid valve (54) is positioned on a line (52) which defines a supply outlet connected to tank (24). The line (52) branches from the supply line (12) at a point downstream of a water meter (8) and upstream of shut-off valve (34). In an exemplary embodiment, another solenoid valve (58) is positioned on a line (56) which defines another supply outlet connected to a drain (60). The line (56) branches from the supply line (12) at a point downstream of main valve (6) and upstream of a water meter (8). The solenoid valves (54, 58) can be actuated by computer (28), as described below.

The purpose of the computer (28) is to control and coordinate the operation of the electrical temperature sensor (30), the shut-off valve (34) the pump (22, 26), and, if provided, other components of the system (10) such as solenoid valves (38, 40, 42, 46, 48, 54, 58) and the flushers. In embodiments, the computer (28) may receive electrical power from the main power supply to the building and/or a battery that is independent from the building power supply. In an exemplary embodiment, the computer (28) forms part of a programmable control panel of the system (10).

The computer (28) comprises a processor and an operatively connected memory. In exemplary embodiments, the processor may comprise a microprocessor (i.e., a computer processor on an integrated circuit device), or a field-programmable gate array (FPGA). The memory comprises a non-transitory computer readable medium that stores instructions that are readable by the processor to control and coordinate the components of the system, and implement the methods described below. In exemplary embodiments, the memory may comprise a volatile memory (i.e., memory that requires power to maintain the stored data) as well as a non-volatile memory (i.e., memory that can be retrieved after power to the memory has been cycled on and off). In exemplary embodiments, the memory may comprise solid-state flash memory, but may also comprise other types of computer readable media (e.g., magnetic media, and optical media), as known to persons skilled in the art.

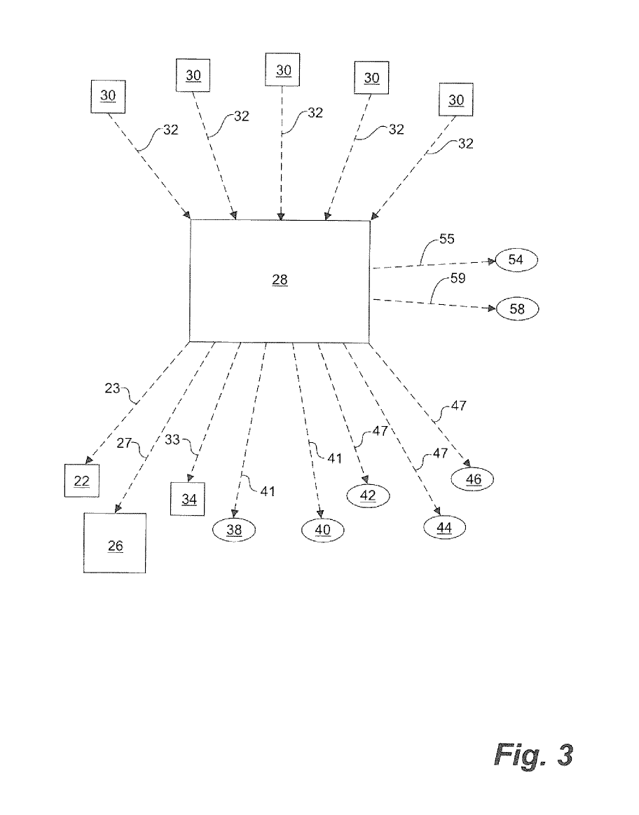

In the exemplary embodiment shown in FIG. 3, the processor of computer (28) is operatively connected to the electronic temperature sensors (30) so as to transmit electronic input signals and/or output signals (32, 23, 27, 33, 41, 47, 49, 55, 59) to or from vacuum pump (22), air compressor pump (26), shut-off valve (34), and solenoid valves (38, 40, 42, 44, 46, 54, 58), respectively, so as to implement a method as described below. The operative connection between the computer (28) and the components of the system (10) may be implemented through electronic signals that are transmitted either through wired and/or wireless connections, and processed in accordance with suitable communication protocols that are known in the art.

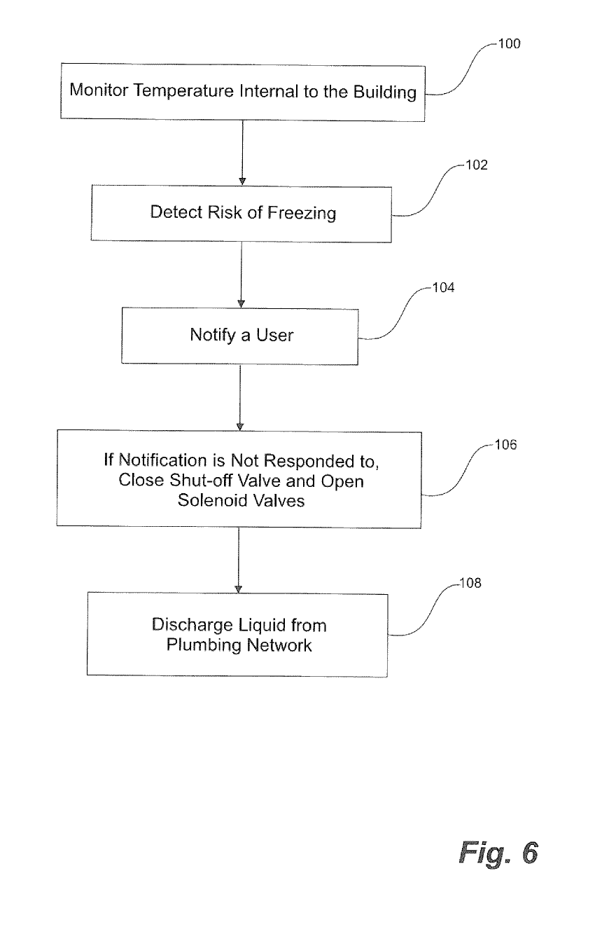

The use and operation of the system (10) is now described with reference to FIG. 6. Ordinarily, the system (10) is in a standby state in which the temperature sensors (30) detect the temperature internal to the building and send signals (32) to the computer (28) (step 100). In this standby state, the shut-off valve (34) is open to allow water to enter the plumbing network (11) via the supply line (12). At the same time, solenoid valves (42, 44, 46) as shown in FIG. 2 are closed, and solenoid valves (38, 40) as shown in FIGS. 4A and 4B are also closed. At the same time, solenoid valves (54, 58) as shown in FIG. 5 are closed.

The computer (28) monitors and processes the signals (32) from the electric temperature sensors (30) to determine if the temperature is within a predetermined range of a threshold temperature (i.e., a risk of freezing) (step 102). As a non-limiting example, the computer (28) may determine whether the temperature is within a range of 5 degrees Celsius of 0 degrees Celsius, or some other range depending on the desired risk tolerance of the system (10) and the liquid in question.

In response to the computer (28) detecting that the temperature is within a range of the threshold temperature, the computer (28) takes a related action. In exemplary embodiments, the related action comprises notifying a user at step (step 104) of the detected risk. As a non-limiting example, notifying the user may comprise generating an audible or visible alarm. As another non-limiting example, notifying the user may comprise generating a notification (e.g., a message or an alert) and transmitting the notification via a communications network to a user-operated computer device. In embodiments, the communications network may comprise one or a combination of cable-connected buses, a local area network (LAN), a client-server network, a wide area network including the Internet, a cellular telephone network, an infrared network, or a satellite network. In embodiments, the user-operated computer device may comprise one or a combination of a general-purpose desktop computer, laptop computer, tablet computer or smartphone.

In an exemplary embodiment, the system (10) waits to receive a user-generated response to the notification before proceeding to steps (106, 108), which is conditional on not receiving the response within a specified amount of time (e.g., 10 minutes). As non-limiting examples, the computer (28) may receive the user-generated response via a key pad, or via a transmission from the user-operated computer device via the communications network. If the response is received within the specified amount of time, the system (10) does not proceed to steps (106, 108). Thus, the system (10) provides the user with an opportunity to override the system (10) and prevent it from proceeding to steps (106, 108) if the user so desires.

In exemplary embodiments, the related action further comprises generating and transmitting signals (33, 41, 47, 55, 59) to close the shut-off valve (34), to open solenoid valves (38, 40, 42, 44, 46, 54, 58) (step 106) so that the system (10) is a discharge state. In the discharge state, shut-off valve (34) prevents water from entering the plumbing system via the supply line (12). Solenoid valve (42) allows water to flow from the remainder of the plumbing network (11) to the liquid drain (13). Solenoid valve (44) allows water to flow from the liquid drain (13) via line (17) into the tank (24). Solenoid valve (46) allows pressurized air to flow from air compressor pump (26) via line (15) to the liquid drain (13) and the remainder of the plumbing network (11). Solenoid valve (38) allows air to flow into the upper floor line (16) via auxiliary line (36) of auxiliary valve assembly (35), which allows air to be drawn into the upper floor lines (16) to facilitate the flow of water from the upper flow lines (16) to water tank (24). Solenoid valve (40) allows water to flow from the lower floor line (18) towards the liquid drain (13) and ultimately to tank (24), or to another drain via auxiliary line (36) of auxiliary valve assembly (39). Solenoid valve (54) allows water to flow from the supply line (12) to tank (24) via line (52). Solenoid valve (58) allows water to flow from the supply line (12) to drain (60) via line (56). It will be appreciated that with shut-off valve (34) closed and main valve (6) open, water from the municipal water line will continue to flow into the supply line (12), and as such, supply line (12) is not isolated from the continued presence of water. If solenoid valves (54, 58) were to remain closed, water in the supply line (12) would cease to circulate. However, by virtue of the solenoid valves (54, 58) being open, water in the supply line (12) upstream of shut-off valve (34) will continue to circulate, and thereby reduce the risk of the water freezing in the supply line (12).

In the exemplary embodiment, once the system is in the discharge state (10), the related action further comprises generating signal (23) to activate the vacuum pump (22) to discharge water from the upper floor lines (16) of the plumbing network (11) (step 108). In the exemplary embodiment, the vacuum pump (22) creates negative pressure (i.e., a suction) in the upper floor lines (16), which results in the liquid being drawn out of these lines into tank (24) (step 108). In the exemplary embodiment, the tank (24) is located below the upper floor lines (16) so that gravity can assist in drawing liquid out of the upper floor lines (16). In the exemplary embodiment, once the system is in the discharge state (10), the related action further comprises generating signal (27) to activate the air compressor pump (26). The air compressor pump (26) pressurizes air into the lower floor lines (18) to purge water from the lower floor lines (18) of the plumbing network (11) via the auxiliary outlet of auxiliary line (36) of auxiliary valve assembly (39) (step 108) to another liquid drain (e.g., a basement floor drain or a sink drain). In an exemplary embodiment, the computer (28) is programmed so that the system (10) discharges the upper floor lines (16) and the lower floor lines (18) sequentially. As a non-limiting example, computer (28) is programmed so that the system (10) discharges the upper floor lines (16) first and then the lower floor lines (18) only after the upper floor lines (16) have been discharged. In other exemplary embodiments, the computer (28) is programmed to drain each upper floor line (16) and lower floor line (18) simultaneously.

In exemplary embodiments, the related action further comprises transmitting signals to activate the electromechanical actuators to flush one or more toilets in the building.

Although an exemplary embodiment of the present invention has been shown and described above, it will be appreciated by those skilled in the art that various changes and modifications might be made without departing from the scope of the invention. The terms and expressions used in the preceding description have been used herein as terms of description and not of limitation, and there is no intention in the use of such terms and expressions of excluding equivalents of the features shown and described or portions thereof, it being recognized that the invention is defined and limited only by the claims that follow.

While the above description details certain embodiments of the invention and describes certain embodiments, no matter how detailed the above appears in text, the invention can be practiced in many ways. Details of the systems and methods may vary considerably in their implementation details, while still being encompassed by the invention disclosed herein. These and other changes can be made to the invention in light of the above description.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification. Accordingly, the actual scope of the invention encompasses not only the disclosed embodiments, but also all equivalent ways of practicing or implementing the invention.

The above description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. The elements and uses of the various embodiments described above can be combined to provide further embodiments.

What is claimed is:

1. A system for automated prevention of freezing of a liquid in a plumbing network connected to a liquid source and a liquid drain, the system comprising:
at least one electrical temperature sensor;
an electromechanical shut-off valve actuable to prevent the liquid from flowing from the liquid source to at least a portion of the plumbing network;
a pump for discharging the liquid from the portion of plumbing network to the liquid drain; and
a processor operatively connected to the temperature sensor, the shut-off valve, the pump, and a non-transitory medium storing instructions readable by the processor to implement a method comprising the steps of:
determining if the temperature detected by the electrical temperature sensor is within a predetermined range of a threshold temperature;
in response to determining that the temperature is within the predetermined range of the threshold temperature, taking a related action comprising:
actuating the shut-off valve to prevent the liquid from flowing from the liquid source to the portion of the plumbing network; and
actuating the pump to discharge the liquid from the portion of the plumbing network to the liquid drain.

2. The system of claim 1 wherein the plumbing network defines an auxiliary inlet or outlet, and the system further comprises:
an electromechanical auxiliary valve actuable to close and open the auxiliary inlet or outlet;
wherein the processor is operatively connected to the auxiliary valve; and
wherein the related action further comprises:
actuating the auxiliary valve to open the auxiliary inlet or outlet.

3. The system of claim 1 wherein:
the pump comprises an air compressor pump; and
actuating the pump to discharge the liquid from the portion of the plumbing network to the liquid drain comprises the air compressor pump pressurizing air into the plumbing network.

4. The system of claim 1 wherein:
the pump comprises a vacuum pump; and
actuating the pump to discharge the liquid from the portion of the plumbing network to the liquid drain comprises the vacuum pump creating a suction to draw the liquid out of the plumbing network.

5. The system of claim 1 wherein the related action further comprises generating an audible or visual notification that the temperature is within the predetermined range of the threshold temperature.

6. The system of claim 5 wherein the related action further comprises waiting to receive a response to the notification, and wherein either actuating the shut-off valve or actuating the pump, or both actuating the shut-off valve and actuating the pump is conditional on not receiving the response within a predetermined amount of time from generating the notification.

7. The system of claim 1 wherein a supply line connects the liquid source to the plumbing network and the supply line defines a supply line outlet upstream of the shut-off valve, wherein:
the system further comprises an electromechanical supply valve actuable to open the supply line outlet;
wherein the processor is operatively connected to the supply valve; and
wherein the related action further comprises:
actuating the supply valve to open the supply line outlet.

8. A computer-implemented method for preventing freezing of a liquid in a plumbing network connected to a liquid source and a liquid drain, the method comprising:
determining if the temperature detected by at least one electrical temperature sensor is within a predetermined range of a threshold temperature; and
in response to determining that the temperature is within the predetermined range of the threshold temperature, taking a related action comprising:
actuating an electromechanical shut-off valve to prevent the liquid from flowing from the liquid source to at least a portion of the plumbing network; and
actuating the pump to discharge the liquid from the portion of the plumbing network to the liquid drain.

9. The method of claim 8 wherein the plumbing network defines an auxiliary inlet or outlet, and the system further comprises:
actuating an electromechanical auxiliary valve actuable to close and open the auxiliary inlet or outlet.

10. The method of claim 8 wherein the pump is an air compressor pump and actuating the pump to discharge the liquid from the portion of the plumbing network to the liquid drain comprises the air compressor pump pressurizing air into the plumbing network.

11. The method of claim 8 wherein the pump is a vacuum pump and actuating the pump to discharge the liquid from the portion of the plumbing network to the liquid drain comprises the vacuum pump creating a suction to draw the liquid out of the plumbing network.

12. The method of claim 8 wherein the related action further comprises generating an audible or visual notification that the temperature is within the predetermined range of the threshold temperature.

13. The method of claim 12 wherein the related action further comprises waiting to receive a response to the notification, and wherein either actuating the shut-off valve or actuating the pump, or both actuating the shut-off valve and actuating the pump is conditional on not receiving the response within a predetermined amount of time from generating the notification.

14. The method of claim 8 wherein a supply line connects the liquid source to the plumbing network and the supply line defines a supply line outlet upstream of the shut-off valve, wherein the related action further comprises actuating an electromechanical supply valve to open the supply line outlet.
